(19) United States
(12) Patent Application Publication
(10) Pub. No.: US 2015/0095349 A1
(43) Pub. Date: Apr. 2, 2015

(54) AUTOMATICALLY IDENTIFYING MATCHING RECORDS FROM MULTIPLE DATA SOURCES

(71) Applicant: Microsoft Corporation, Redmond, WA (US)

(72) Inventors: Bogdan A. Sturzoiu, Copenhagen (DK); M. Cavit Ilker, Copenhagen (DK)

(73) Assignee: Microsoft Corporation, Redmond, WA (US)

(21) Appl. No.: 14/160,554

(22) Filed: Jan. 22, 2014

Related U.S. Application Data
(60) Provisional application No. 61/883,784, filed on Sep. 27, 2013.

(51) Int. Cl. G06F 17/30

(52) U.S. Cl. CPC G06F 17/3053
USPC 707/748

(57) ABSTRACT

A system identifies matching records from two or more different data sources. The system applies a scoring algorithm to identify potential matching pairs of records. A score is provided for each candidate pair of records. Records are pre-filtered based on predefined attributes. The scoring algorithm is applied to the filtered records. A set of potential matches are provided with a corresponding score. The set of potential matches are presented in a descending score order. A decision may be made for a best match based on the scores.

### RELATED APPLICATIONS

This application claims priority to U.S. Provisional Application Ser. No. 61/883,784 filed on Sep. 27, 2013. The provisional application is hereby incorporated by reference in its entirety.

### BACKGROUND

In a business environments, businesses employ enterprise management applications for managing complex business operations. An enterprise management application is a comprehensive business management solution to enable businesses to increase productivity. The enterprise management application enables businesses to manage aspects of the business, such as finances and accounting, human resources, payroll, business intelligence and reporting, manufacturing, supply chain management, inventory, sales, and service and project management.

A large amount of data is usually associated with operations of businesses. The data is usually hosted in variety of local and remote data sources. Business processes make it a priority to identify matching records from two or more data sources. Manually searching data sources for related and matching records may be time consuming, inefficient and error prone.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a system for identifying matching records from two or more different data sources. The system may apply a scoring algorithm to identify candidate matching pairs of records. A score may be provided for each candidate matching pair of records. Records may be pre-filtered based on predefined attributes. The scoring algorithm may be applied to the filtered records. A set of potential matches may be provided with a corresponding score. The set of potential matches may be presented in a descending score order. A decision may be made for a best match based on the scores.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example environment where one or more data stores may be accessed over a network to automatically identify matching records;

FIG. 2 illustrates an example scheme for a scoring algorithm to automatically identify matching record candidates;

FIG. 3A and FIG. 3B illustrate application of a scoring algorithm to match records from multiple data sources;

FIG. 4 illustrates another example of applying a scoring algorithm to match records from multiple data sources;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing a system to automatically score data records to identify matching candidates from multiple data sources, according to embodiments.

### DETAILED DESCRIPTION

As briefly described above, a system is provided for identifying matching records from two or more different data sources. The system may apply a scoring algorithm to identify candidate pairs of records. A score may be provided for each candidate pair of records. Records may be pre-filtered based on predefined attributes. The scoring algorithm may be applied to the filtered records. A set of potential matches may be provided with a corresponding score. The set of potential matches may be presented in a descending score order. A best match may be selected based on the scores.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to identify matching records from multiple data sources. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

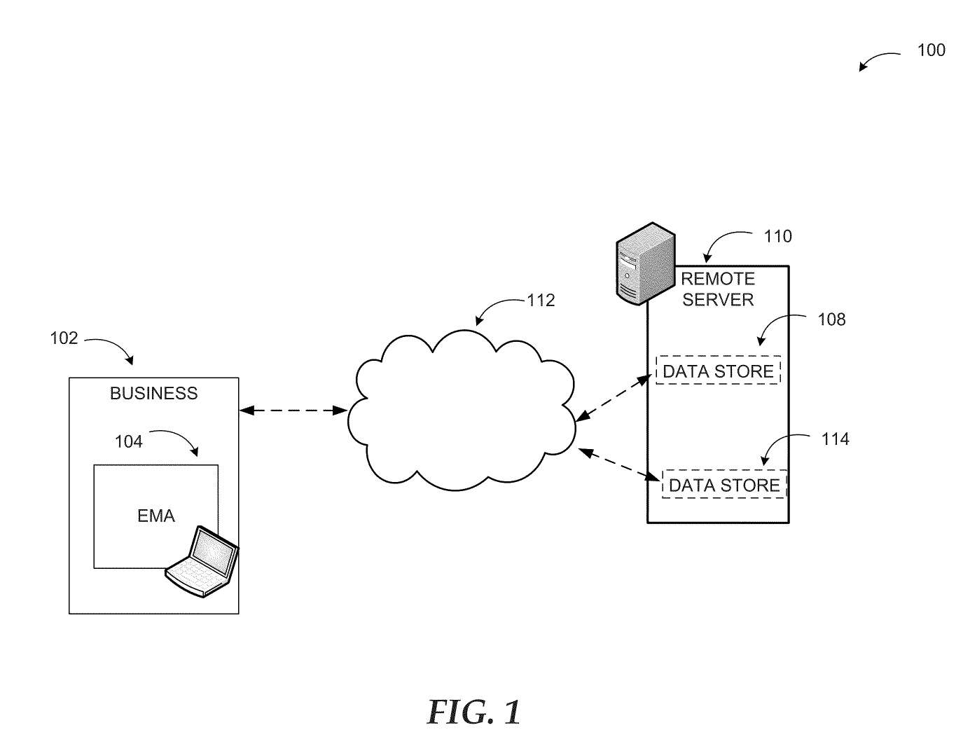

FIG. 1 illustrates an example environment where one or more data stores may be accessed over a network to automatically identify matching records, according to some embodiments herein. As illustrated in diagram 100, a business 102 may utilize a business management application, such as an enterprise management application (EMA) 104. The EMA may be a comprehensive business management solution to enable businesses to increase productivity. The EMA may manage many complex aspects of the business, including financial management, accounting, human resources, payroll, business intelligence, reporting, manufacturing, supply chain management, inventory, sales, service and project management, and similar ones. Tools associated with EMA 104 may enable users to access and analyze real-time data about aspects of the business operations, finances, resources, decision-defining information, and similar ones. Data related to the business operations, finances, and other aspects may be maintained by multiple data stores 108 and 114 at a remote server 110. The data may be accessed by individual applications executed on a plurality of client devices over a network, such as a cloud based network 112.

In a system according to embodiments, it may be preferable to access data from two or more separate data stores to identify corresponding or matching data in order to reconcile business processes. In some examples, it may be preferable to manually sort through the data stores to identify candidate matching records from the separate data stores to identify the corresponding data matches. Manually sorting through the data stores can be time consuming and error prone. A system according to embodiments may provide a system for automatically identifying matching records from multiple data sources, and may score each match to provide a relative indication of the match likelihood.

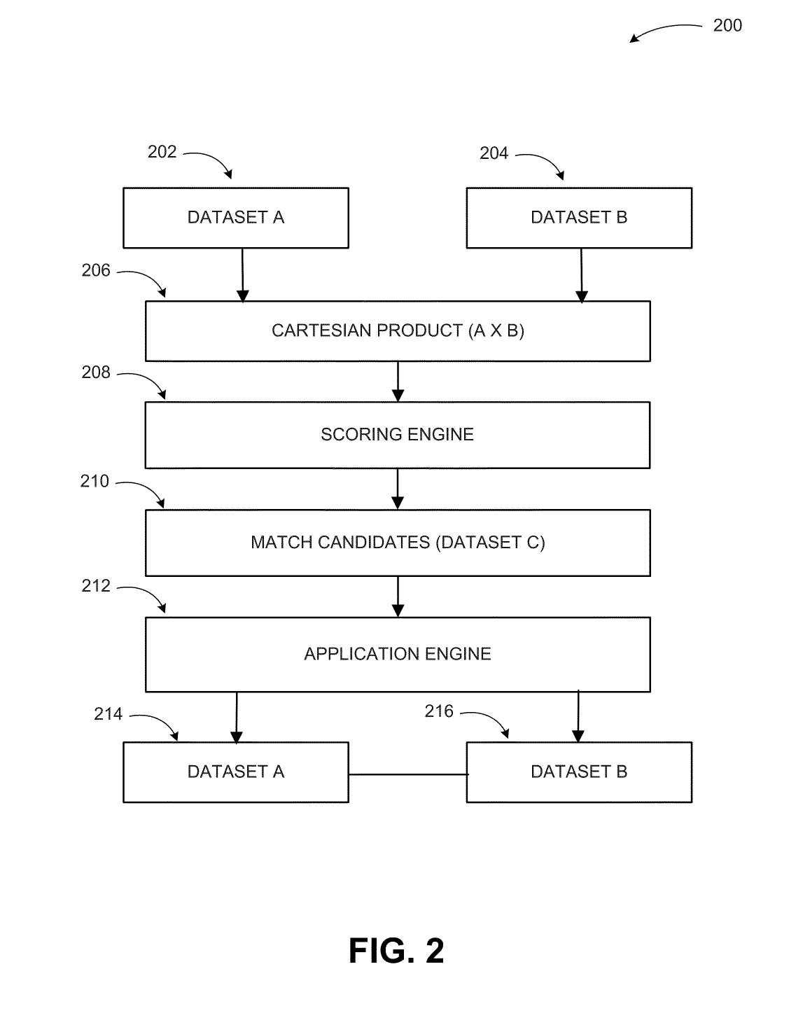

FIG. 2 illustrates an example scheme for a scoring algorithm to automatically identify matching record candidates, according to some embodiments herein. As illustrated in diagram 200, a scoring engine 208 may facilitate identification of matching records from multiple data sources, and may score each match to provide a relative indication of the match likelihood.

In an example embodiment, two datasets from two data sources, such as dataset A 202 and dataset B 204, may be matched based on a set of attributes. A filtered Cartesian product 206 (e.g., A×B) of the datasets A 202 and B 204 may be created by the scoring engine 208. Prior to creating the Cartesian product 206, the datasets A 202 and B 204 may be filtered to contain only a minimal set of records that could represent matches based on predefined criteria. The predefined criteria may be defined by a user or may be a default criteria associated with a particular dataset or business application. For example, after filtering, dataset A 202 may include n records, and dataset B 204 may include m records.

After creation of the Cartesian product 206 of the datasets A 202 and B 204, the scoring engine 208 may iterate through each pair of records inside the Cartesian product 206 to identify every possible combination of matching records. For example, the scoring engine 208 may iterate through each pair (A(i),B(j)), where i goes from 1 to n and j goes from 1 to m. The scoring engine 208 may initially determine if a pair, (A(i),B(j)), may be excluded from the list of potential matches based on specific predefined criteria. Example predefined criteria may include data outside a predefined date or time range.

After excluding pairs of data, the scoring engine 208 may compute a score for each combination of matching records to indicate a likelihood of the match. The score, S(i,j), may be computed based on comparison of a set of p common attributes, S(i,j)=Σₖ₌₁^{p}s(i, j, k). The attributes may be predefined attributes such as a defined similarity, positive or negative signs for record values, and other similar attributes.

Additionally, a threshold score may be defined such that if a resulting score is above a given threshold, then the pair may be saved as a match candidate. If a score is below the given threshold, the pair may be discarded and not saved as a match candidate. The match candidates may be saved in a buffer data source.

In another example embodiment, after scoring each pair of candidates, a set of match candidates 210 may be provided. In an example scenario, a dataset C may be the match candidates 210 resulting from scoring of the match candidates 210. Every record in the match candidates 210 (the dataset C) may represent a pair of elements A(i), B(j). The score of each pair of the match candidates 210 may be determined by S(i,j): C(k)=(A(i), B(j), S(i,j)). The match candidates 210 (dataset C) may be sorted based on a descending score value.

In order to automatically select a most likely match, for each C(k), the scoring engine 208 may apply A(i) to B(j), starting at the highest score presented at the top of the list, as long as neither A(i) nor B(j) have been previously applied to any other element in the candidates set. The scoring engine 208 may automatically select a most likely match based on predefined criteria and a computed score. An application engine 212 may select a matching pair of records from each of the dataset A 214 and the dataset 216 based on the most likely match determined by scoring engine 208.

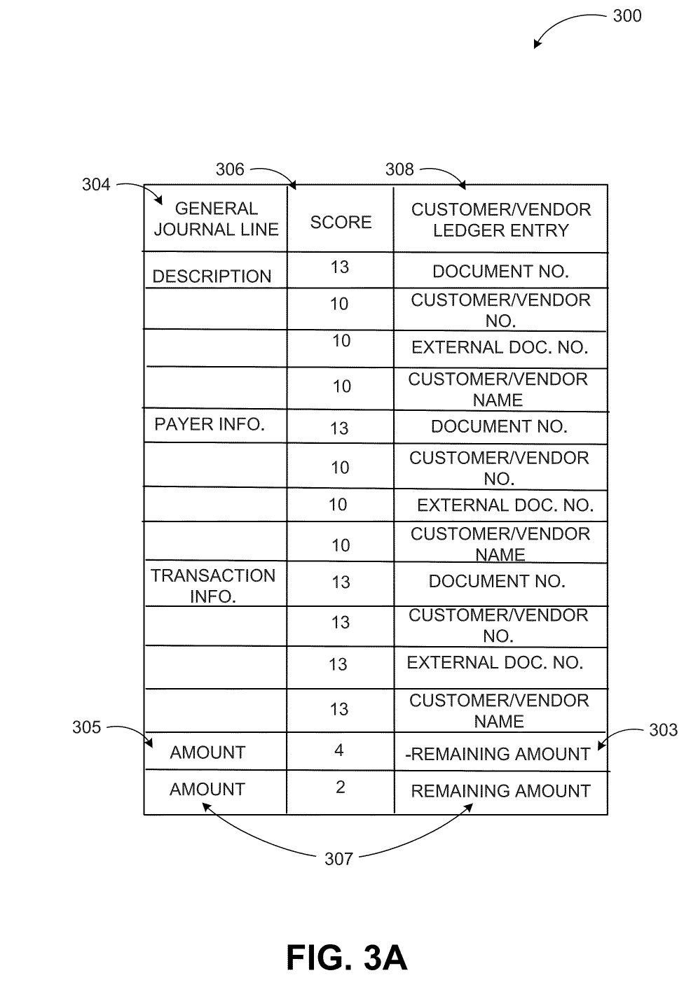

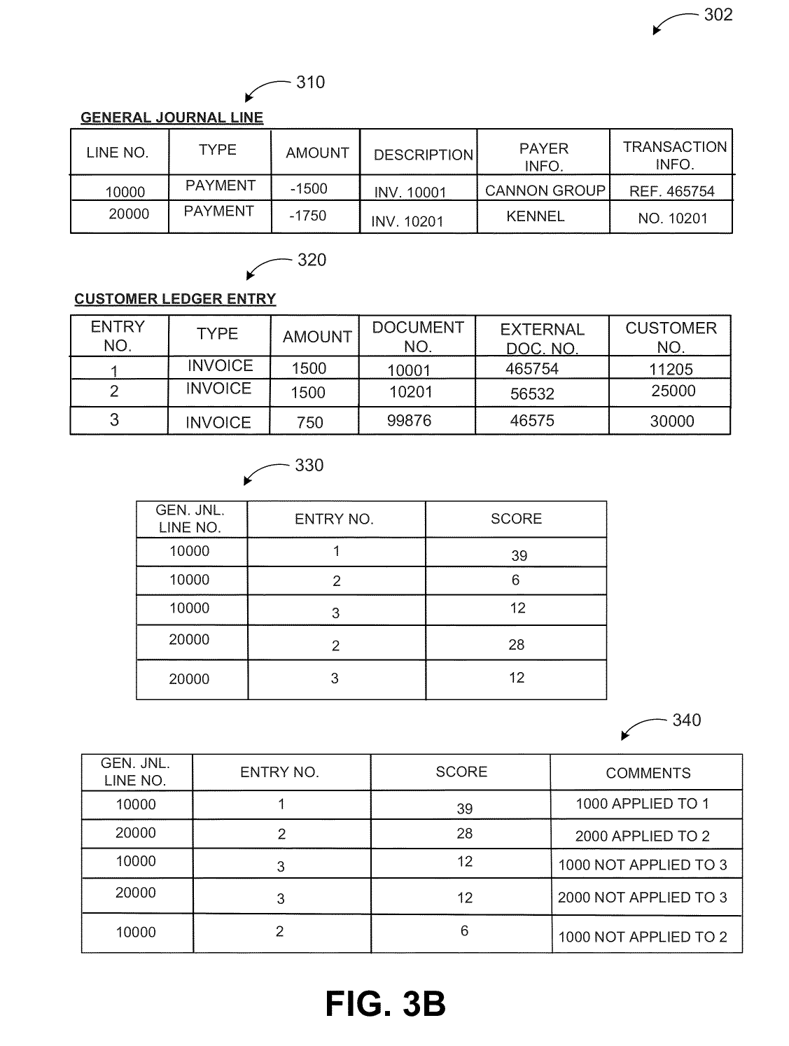

FIG. 3A and FIG. 3B illustrate application of a scoring algorithm to match records from multiple data sources, according to some example embodiments herein.

As illustrated in diagram 300, example datasets may include a general journal line dataset 304 and a customer/vendor ledger entry dataset 308. It may be desirable to automatically identify matching or corresponding records from the datasets 304 and 308 by employing a scoring algorithm.

In a system according to embodiments, a scoring engine may pre-filter the datasets 304 and 308 based on predefined criteria. In an example scenario, a first predefined criterion may be unapplied payments in the general journal lines dataset 304. A second predefined criterion may be an empty account number in the customer/vendor entry dataset 308.

After pre-filtering the datasets 304 and 308, the scoring engine may identify possible pair combinations and may compute a score for each pair. Once each pair combination has been identified, some pairs may be excluded based on predefined criteria or business logic rules. In an example scenario, a rule may state that a remaining amount 303 on the customer/vendor entry dataset 308 and the payment amount 305 may need to have an opposite sign. If the records have the same sign, then the pair 307 may be excluded. Additionally, a rule may state that a payment posting date may need to be later or equal to a posting date in the customer/vendor entry dataset 308. Records not matching the rule may be automatically excluded prior to scoring. After excluding non-matching data records, the scoring engine may score the candidate pairs based on attributes. The score of each pair of records may be stored in a score dataset 306 in association with the pair of records in the general journal line dataset 304 and customer/vendor ledger entry dataset 308.

In an example embodiment, a string comparison may be applied for computing a score. The string comparison may be based on a normalized nearness function. Steps of the string comparison may include computing a longest common substring (LCS) of two compared strings of data, dividing the LCS length by the length of the shortest common substring, and computing the score by normalizing the computed value between 1 and 10.

The scores may be computed according to the algorithm previously described, where a set of p common attributes for each record of the datasets are compared. An example algorithm may be S(i,j)=Σₖ₌₁^{p}s(i, j, k). A set of match candidates may be provided where the match candidates may be sorted in descending score order. Match candidates having a score below a defined threshold value may be excluded from the set of match candidates. After sorting the set of match candidates, each record from a first dataset may be applied to a record from the second dataset to register the records as a matching pair. In an example scenario, the general journal lines dataset 304 may be applied to the customer/vendor ledger entry dataset 308 and registered as match candidates.

Diagram 302 illustrates an example implementation of a scoring algorithm for the two datasets, general journal line dataset 310 and a customer ledger entry dataset 320. In an example scenario, the records in the datasets 310 and 320 may be pre-filtered to display eligible records. The scoring engine may iterate through the records of the datasets 310 and 320 to identify potential matching records. The scoring engine may compute a score for each matching pair of records. The matching records and corresponding scores may be presented in a scoring table 330. Any pair not having a score above a predetermined threshold may be excluded from the scoring table 330.

Subsequently, the scoring table 330 may be processed to present the candidate pairs in a descending score order in the scoring table 340. The scoring engine may then process each matching pair to determine a likely match by applying a record from the dataset 310 to the dataset 320 starting with a highest score. For example, as shown in table 340, record 10000 is applied to record 1, and record 20000 is applied to record 2. In subsequent pairs, records 1000 and 2000 are not applied to the corresponding matches because the records were already applied to matches with higher scores.

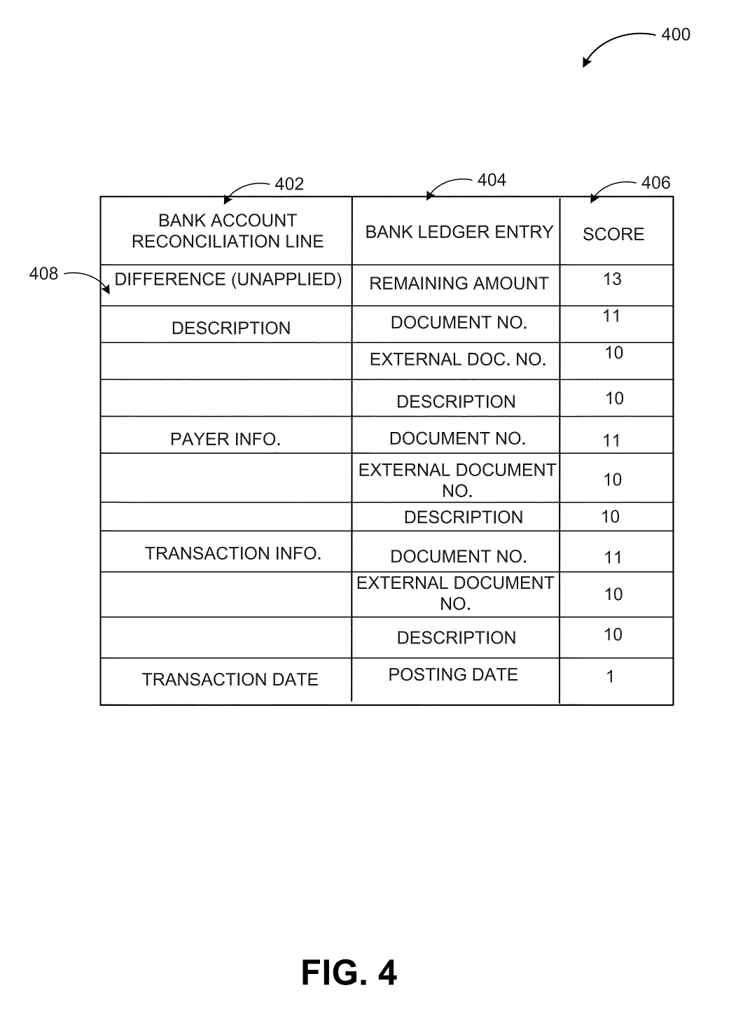

FIG. 4 illustrates another example of applying a scoring algorithm to match records from multiple data sources, according to some example embodiments herein.

As demonstrated in diagram 400, a scoring algorithm may be applied to match records from a bank account reconciliation line dataset 402 and a bank ledger entry dataset 404. The datasets 402 and 404 may be pre-filtered based on predefined criteria. In an example scenario, an unapplied bank account reconciliation line record (408) may be considered within a predefined criterion. An unapplied bank ledger entry may be considered to be within another predefined criterion. The datasets 404 and 404 may be filtered based on the predefined criteria. After filtering, the scoring engine may identify all potential matches and apply the scoring algorithm to compute a score for each potential match. Records may be excluded based on predefined attributes. In an example scenario, if a transaction date for a record of the bank account reconciliation line dataset 402 is outside a requested date range when compared to a bank entry posting date, the record may be excluded.

In addition, a score may be computed by applying a scoring algorithm based on attributes of the matching pair of records. For example, string values may be computed, and a bonus point may be added to a score based on predefined criteria, such as exact date matching between records. Matches having a score less than a predetermined threshold value may be excluded. After computing the scores, the matching records may be sorted based on descending scores 406, and the scoring engine may apply records of the bank account reconciliation lines dataset 402 to records of the bank ledger entry dataset 404 starting with a highest score to select a likely match.

The example applications, devices, and modules, depicted in FIGS. 1-4 are provided for illustration purposes only. Embodiments are not limited to the configurations and content shown in the example diagrams, and may be implemented using other engines, client applications, service providers, and modules employing the principles described herein

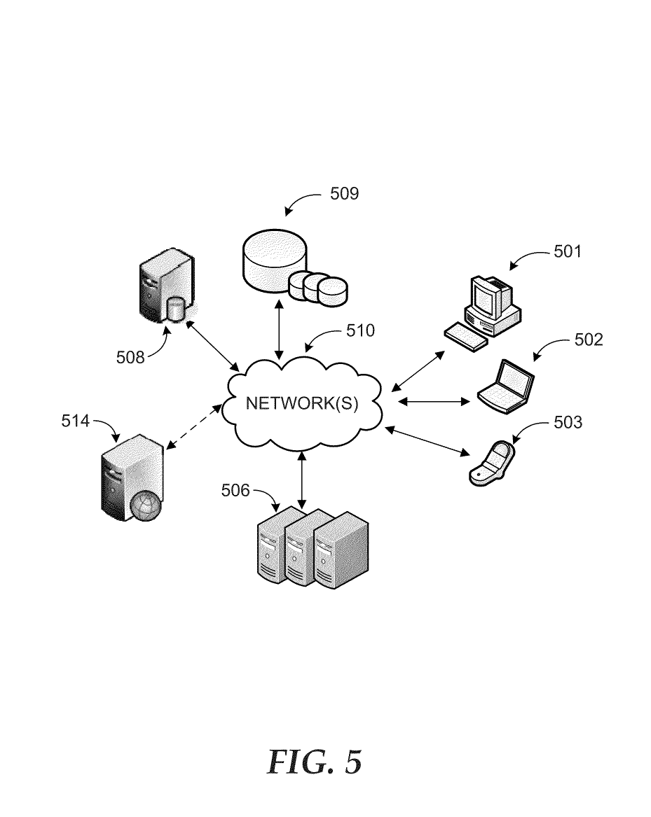

FIG. 5 is an example networked environment, where embodiments may be implemented. In addition to locally installed applications, a scoring application may also be employed in conjunction with hosted applications and services that may be implemented via software executed over one or more servers 506 or individual server 508. A hosted service or application may communicate with client applications on individual computing devices such as a handheld computer, a desktop computer 501, a laptop computer 502, a smart phone 503, a tablet computer (or slate), (client devices′) through network(s) 510 and control a user interface presented to users.

Client devices 501-503 are used to access the functionality provided by the hosted service or application. One or more of the servers 506 or server 508 may be used to automatically identify matching records from multiple data sources. Relevant data may be stored in one or more data stores (e.g. data store 509), which may be managed by any one of the servers 506 or by database server 514.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to automatically score data records to identify matching candidates from multiple data sources. Furthermore, the networked environments discussed in FIG. 5 are for illustration purposes only. Embodiments are not limited to the example applications, modules, or processes.

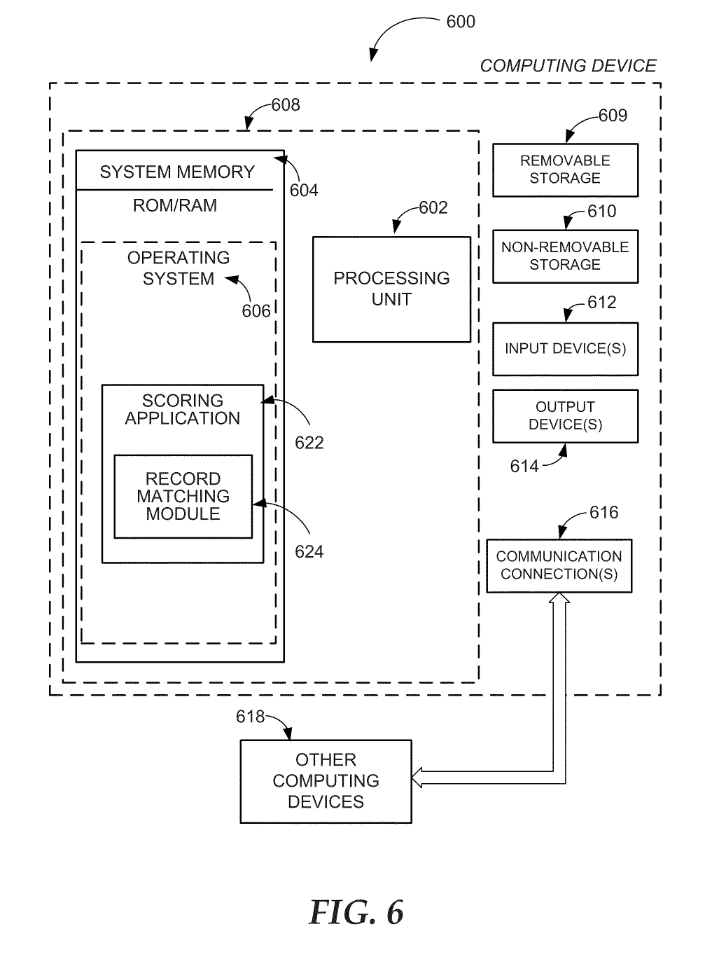

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any touch and/or gesture enabled device in stationary, mobile, or other form such as the example devices discussed in conjunction with FIGS. 1-4 and may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as scoring application 622 and record matching module 624.

The record matching module 624 may operate in conjunction with the operating system 606 or scoring application 622 to identify candidate record matches from multiple data sources, and to compute a score for each candidate record pair. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 615 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

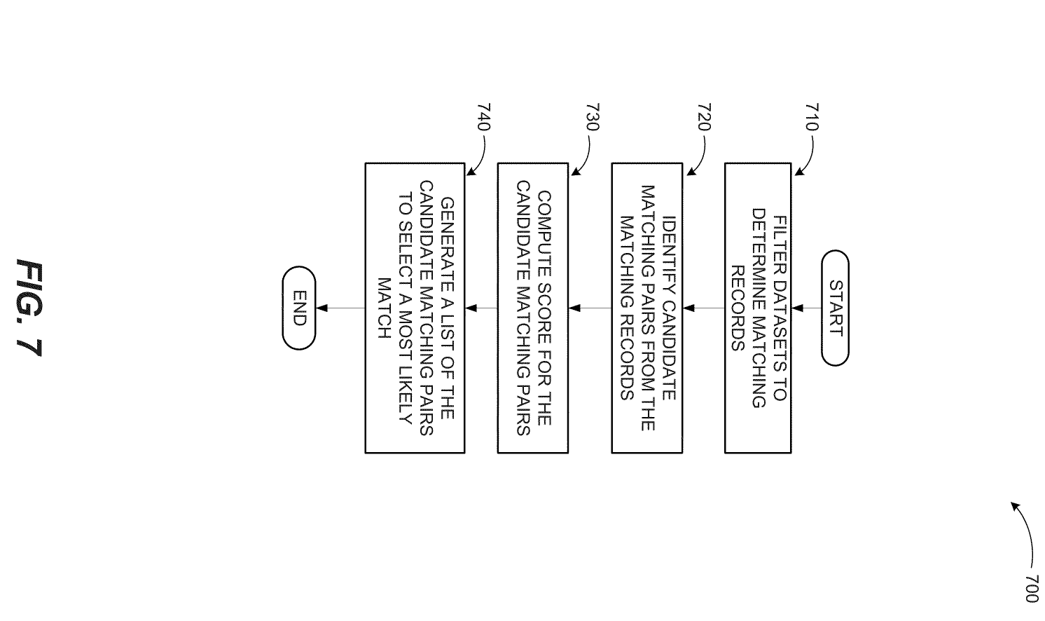

FIG. 7 illustrates a logic flow diagram for a process of providing a system to automatically score data records to identify matching candidates from multiple data sources, according to embodiments. Process 700 may be implemented as part of an application or an operating system.

Process 700 begins with operation 710, “FILTER DATASETS TO DETERMINE MATCHING RECORDS,” where at least two separate data sets may be filtered to include only a minimal set of records that could represent matches.

Operation 710 is followed by operation 720, “IDENTIFY CANDIDATE MATCHING PAIRS FROM THE MATCHING RECORDS,” where a Cartesian product of the two datasets may be computed and a scoring engine may iterate through each pair of records inside the Cartesian product to identify combination of matching pairs.

Operation 720 is followed by operation 730, “COMPUTE SCORE FOR THE CANDIDATE MATCHING PAIRS,” where the scoring engine may compute a score for each of the candidate matching pair of records.

Operation 730 is followed by operation 740, “GENERATE A LIST OF THE CANDIDATE MATCHING PAIRS TO SELECT A MOST LIKELY MATCH,” where the scoring engine may sort the candidate matching pairs in a list based on a descending computed score. Starting with a match candidate with a highest score, the scoring engine may apply a record from the first dataset to the second dataset as long as neither record has been previously applied to any other record in the match candidates list to identify the most likely match.

The operations included in process 700 are for illustration purposes. Providing a system to automatically score data records to identify matching candidates from multiple data sources according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to automatically select matching records from data sources, the method comprising:
identifying at least two datasets from the data sources;
filtering the at least two datasets to determine the matching records;
identifying candidate matching pairs from the matching records;
computing a score for each of the candidate matching pairs; and
identifying a most likely match based on the score.

2. The method of claim 1, further comprising:
filtering the at least two datasets based on predefined criteria to include a minimal set of records of the at least two datasets.

3. The method of claim 1, wherein further comprising:
computing a Cartesian product for the at least two datasets.

4. The method of claim 1, wherein identifying the candidate matching pairs comprises:
iterating through each of the candidate matching pairs inside a Cartesian product for the at least two datasets to identify a combination of the matching records.

5. The method of claim 4, further comprising:
excluding one or more of the candidate matching pairs based on predefined criteria.

6. The method of claim 1, wherein computing the score for each of the candidate matching pairs comprises:
applying a scoring algorithm to each of the candidate matching pairs based on a comparison of a set of common attributes of the candidate matching pairs.

7. The method of claim 6, wherein the scoring algorithm comprises: S(i,j)=Σₖ₌₁^{p}s(i, j, k), wherein p is the set of common attributes, s is the score, i is a total number of records in a first dataset of the at least two datasets, j is a total number of records in a second dataset of the at least two datasets, and k is a total number of the candidate matching pairs.

8. The method of claim 1, further comprising:
generating a list of the candidate matching pairs in a descending order based on the score of each of the candidate matching pairs.

9. The method of claim 8, further comprising:
selecting the most likely match from the list of the candidate matching pairs based on one of the candidate matching pairs having the score at a top of the list.

10. The method of claim 1, further comprising:
excluding one or more of the candidate matching pairs having the score below a predefined threshold value.

11. A computing device to automatically select matching records from data sources, the computing device comprising:
a memory;
a processor coupled to the memory, the processor executing a scoring engine, wherein the scoring engine is configured to:
identify at least two datasets from the data sources;
filter the at least two datasets to determine the matching records;
identify candidate matching pairs from the matching records;
compute a score for each of the candidate matching pairs;
identify a most likely match based on the score; and
generate a list of the candidate matching pairs in a descending order based on the score of each of the candidate matching pairs.

12. The computing device of claim 11, wherein the scoring engine is further configured to:
select the most likely match from the list of the candidate matching pairs based on one of the candidate matching pairs having the score at a top of the list.

13. The computing device of claim 11, wherein the scoring engine is further configured to:
apply a string comparison to compute the score.

14. The computing device of claim 13, wherein the scoring engine is further configured to:
determine the string comparison from a normalized nearness function.

15. The computing device of claim 13, wherein the scoring engine is further configured to:
compute a longest common substring (LCS) for each of the candidate matching pairs.

16. The computing device of claim 15, wherein the scoring engine is further configured to:
compute a value by dividing a length of LCS by a length of a shortest common substring for each of the candidate matching pairs.

17. The computing device of claim 16, wherein the scoring engine is further configured to:
compute the score by normalizing the value between a range of 1 to 10.

18. A computer-readable memory device with instructions stored thereon to automatically select matching records from data sources, the instructions including:
identifying at least two datasets from the data sources;
filtering the at least two datasets to determine the matching records;
identifying candidate matching pairs from the matching records;
computing a score for each of the candidate matching pairs;
identifying a most likely match based on the score by:
generating a list of the candidate matching pairs in a descending order based on the score of each of the candidate matching pairs; and
selecting the most likely match from the list of the candidate matching pairs based on one of the candidate matching pairs having the score at a top of the list.

19. The computer-readable memory device of claim 18, wherein the instructions further comprise:
applying a scoring algorithm to each of the candidate matching pairs based on a comparison of a set of common attributes of the candidate matching pairs, wherein the scoring algorithm comprises: S(i,j)=Σₖ₌₁^{p}s(i, j, k), wherein p is the set of common attributes, s is the score, i is a total number of records in a first dataset of the at least two datasets, j is a total number of records in a second dataset of the at least two datasets, and k is a total number of the candidate matching pairs.

20. The computer-readable memory device of claim 18, wherein the instructions further comprise:
applying a string comparison to compute the score;
computing a longest common substring (LCS) for each of the candidate matching pairs;
computing a value by dividing a length of LCS by a length of a shortest common substring for each of the candidate matching pairs; and
computing the score by normalizing the value between a range of 1 to 10.
